(19) United States
(12) Patent Application Publication
(10) Pub. No.: US 2011/0048957 A1
(43) Pub. Date: Mar. 3, 2011

(54) Method for forming an ultrathin Cu barrier/seed bilayer for integrated circuit device fabrication

(75) Inventors: Martina Damayanti, Singapore (SG); Thirumany Sritharan, Singapore (SG); Chee Mang Ng, Singapore (SG)

(73) Assignees: Chartered Semiconductor Manufacturing, Ltd., Singapore (SG); Nanyang Technological University, Singapore (SG)

(21) Appl. No.: 12/584,137

(22) Filed: Sep. 1, 2009

(51) Int. Cl. C25D 5/54; B05D 3/02; B32B 9/00; B32B 15/01

(52) U.S. Cl. 205/162; 427/383.3; 428/688; 428/670

(57) ABSTRACT

A structure and method for forming a relatively thin diffusion barrier/seed bilayer for copper metallization in an electronic device is disclosed. A single layer of an alloy is formed over a dielectric (and possibly the copper layer). The alloy includes a copper platable metal (e.g., ruthenium) and a nitride forming material (e.g., tungsten) and nitrogen. The alloy layer is annealed, and the alloy naturally segregates into two layers. The first layer is a barrier layer including the nitride forming material and nitrogen. The second layer is a seed layer including the copper platable metal.

### TECHNICAL FIELD

The present disclosure relates generally to the manufacture of semiconductor integrated circuit devices, and more particularly, to the manufacture of an ultrathin copper (Cu) barrier/seed bilayer in the fabrication of integrated circuit (IC) devices.

### BACKGROUND

A commonly used diffusion barrier for copper (Cu) metallization in the manufacture of microelectronic devices is a bilayer that comprises tantalum (Ta) and tantalum nitride (TaN). However, it has been determined that a Ta/TaN bilayer is not effective for electrochemical plating of copper (Cu) because the Ta/TaN bilayer has a poor seeding ability. Consequently, it is necessary to use an additional seed layer when a Ta/TaN bilayer is employed. A copper (Cu) seed layer is combined with a physical vapor deposition (PVD) based Ta/TaN bilayer barrier.

As the feature size of microelectronic interconnects continues to become smaller and smaller, the size of a composite barrier/seed bilayer has become disproportionately thick when compared with the via/trench dimensions of modern microelectronic devices. Therefore, it has become very desirable to develop a thinner composite barrier/seed bilayer.

A single layer copper (Cu) platable diffusion barrier is desirable to optimize overall integration by eliminating the need for performing physical vapor deposition (PVD) to form the copper (Cu) layer. One possible candidate for a single layer copper (Cu) platable diffusion barrier is a layer of pure ruthenium (Ru). It has been determined that pure ruthenium (Ru) is a good seed layer that encourages the growth of a desirable (111) texture. It has also been determined, however, that pure ruthenium (Ru) has a poor diffusion barrier performance. It has been determined that heating an assembly of copper/ruthenium/silicon dioxide/silicon (Cu/Ru/SiO₂/Si) to a temperature of three hundred degrees Celsius (300° C.) causes an observable breakdown in barrier performance. Additional details are contained in articles by M. Damayanti et al., JMR 22, 9 (2007) and by M. Damayanti et al., JES 153(6), J41 (2006).

Another possible candidate for a single layer copper (Cu) platable diffusion barrier is a layer of a ruthenium nitrogen (Ru—N) alloy. Reaction sputtered Ru—N layers have been examined in an attempt to improve the barrier performance. The dissolved nitrogen (N) could stuff the grain boundary high diffusion paths in the ruthenium (Ru) to slow down the barrier breakdown. It was found that the reactively sputtered Ru—N layers became amorphous. The amorphous Ru—N layers have a lower intrinsic diffusion rate for an extraneous atom. It was also found, however, that heating the amorphous Ru—N layers to a temperature of two hundred seventy five degrees Celsius (275° C.) crystallizes the layer causing the expulsion of the dissolved nitrogen (N). The nitrogen (N) diffused out of the heated layer. This resulted in a poor barrier performance that was similar to the case of pure ruthenium (Ru). Furthermore, the expelled nitrogen (N) formed deleterious bubbles and voids at the interfaces that destroyed good adhesion between the layers. Additional details are contained in articles by M. Damayanti et al., APL 88, 044101 (2006) and by M. Damayanti et al., ESL 10, 15 (2007).

Accordingly, there is a need in the art for an improved method that provides a single layer highly stable copper (Cu) platable diffusion barrier that comprises a ruthenium-nitrogen (Ru—N) alloy. There is also a need in the art for an improved method that retains the nitrogen (N) within the ruthenium-nitrogen (Ru—N) alloy when the Ru—N alloy is heated. There is also a need in the art for an improved method that avoids the crystallization of the ruthenium (Ru) within the ruthenium-nitrogen (Ru—N) alloy when the Ru—N alloy is heated.

### SUMMARY

In accordance with one embodiment, there is provided a method of manufacturing a diffusion barrier for copper metallization in an electronic device. The method includes providing a copper layer and an insulating layer within the electronic device, and forming over the insulating layer a single layer of an alloy, the alloy comprising a copper platable metal and a nitride forming material and nitrogen.

In yet another embodiment, there is provided a method of manufacturing a diffusion barrier for copper metallization in an electronic device. The method includes providing a dielectric layer within the electronic device, and forming over the dielectric layer a single layer of an alloy comprising ruthenium and tungsten and nitrogen.

In still another embodiment, there is provided a diffusion barrier structure for copper metallization in an electronic device having a copper layer and a dielectric layer. The diffusion barrier structure includes a single layer of an alloy formed over the copper layer and dielectric layer wherein the alloy includes a copper platable metal and a nitride forming material and nitrogen.

In accordance with one embodiment, a single layer of an alloy of the present invention is formed over a dielectric layer of an integrated circuit device. The alloy comprises a copper platable metal (e.g., ruthenium) and a nitride forming material (e.g., tungsten) and nitrogen. When the alloy is annealed, the alloy naturally segregates into two layers. The first layer is a barrier layer that comprises the nitride forming material and nitrogen. The second layer is a seed layer that comprises the copper platable metal.

The copper platable metal may be selected from a group of metals that have an absolute Gibb's free energy formation of metal oxide that is lower than that of copper oxide. The nitride forming material may be selected from a group of nitride forming materials that have an absolute Gibb's free energy formation of metal nitride that is slightly higher than that of silicon nitride.

The foregoing has outlined rather broadly the features and technical advantages of the present disclosure so that those skilled in the art may better understand the detailed description that follows. Additional features and advantages of the present disclosure will be described hereinafter that form the subject of the claims. Those skilled in the art should appreciate that they may readily use the conception and the specific embodiment disclosed as a basis for modifying or designing other structures for carrying out the same purposes of the present disclosure. Those skilled in the art should also realize that such equivalent constructions do not depart from the spirit and scope of the present disclosure in its broadest form.

Before undertaking the Detailed Description below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as future uses, of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 is a diagram of a cross sectional side view illustrating a prior art copper (Cu) metal layer within an integrated circuit structure;

FIG. 2 is a diagram of a cross sectional side view illustrating a deposition of an alloy of the present invention over the copper (Cu) metal layer that is shown in FIG. 1 wherein the alloy comprises ruthenium and a nitride forming material and nitrogen;

FIG. 3 is a diagram of a cross sectional side view illustrating how segregation of layers occurs in the deposited alloy of the present invention when the alloy is annealed;

FIG. 4 is a diagram illustrating a flowchart of an advantageous embodiment of a method of the present invention;

FIG. 5 is a transmission electron microscopy (TEM) bright field micrograph that shows a ruthenium-tungsten-nitrogen (Ru—W—N) alloy that has been deposited over a silicon substrate;

FIG. 6 is a TEM bright field micrograph that shows the ruthenium-tungsten-nitrogen (Ru—W—N) alloy of FIG. 5 after the alloy has been annealed at four hundred degrees Celsius (400° C.);

FIG. 7 is a TEM bright field micrograph that that shows the ruthenium-tungsten-nitrogen (Ru—W—N) alloy of FIG. 5 after the alloy has been annealed at five hundred degrees Celsius (500° C.);

FIG. 8 is a TEM bright field micrograph that that shows the ruthenium-tungsten-nitrogen (Ru—W—N) alloy of FIG. 5 after the alloy has been annealed at six hundred degrees Celsius (600° C.);

FIG. 9 is a TEM bright field micrograph that that shows the ruthenium-tungsten-nitrogen (Ru—W—N) alloy of FIG. 5 after the alloy has been annealed at seven hundred degrees Celsius (700° C.);

FIG. 10 is a TEM bright field micrograph that that shows the ruthenium-tungsten-nitrogen (Ru—W—N) alloy of FIG. 5 after the alloy has been annealed at eight hundred degrees Celsius (800° C.);

FIG. 11 is a TEM bright field micrograph that shows a ruthenium-tungsten-nitrogen (Ru—W—N) alloy film on a silicon substrate after the alloy has been annealed at four hundred degrees Celsius (400° C.) and that shows an interface location (A) and a bulk location (B);

FIG. 12 is a chart showing the results of applying an energy dispersive X-ray (EDX) spectroscopy signal to the interface location (A) of the Ru—W—N alloy film that is shown in FIG. 11; and

FIG. 13 is a chart showing the results of applying an energy dispersive X-ray (EDX) spectroscopy signal to the bulk location (B) of the Ru—W—N alloy film that is shown in FIG. 11.

### DETAILED DESCRIPTION

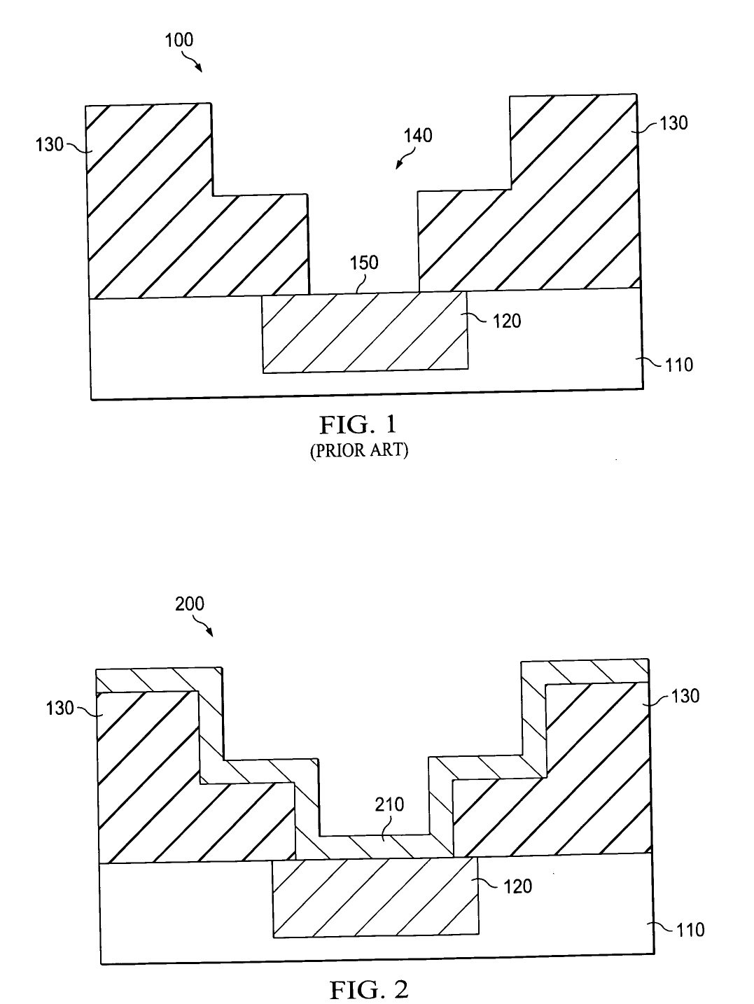

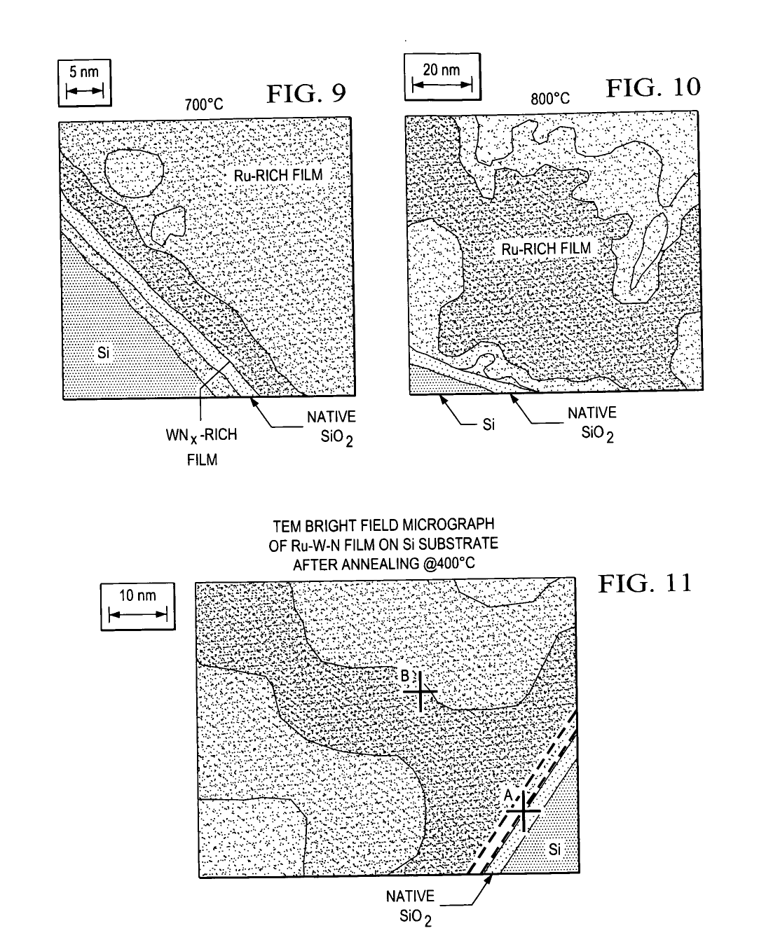

FIGS. 1 through 13 and the various embodiments used to describe the principles of the present disclosure in this patent document are by way of illustration only and should not be construed in any way to limit scope. Those skilled in the art will understand that the principles of the present disclosure may be implemented in any type of suitably arranged semiconductor device.

To simplify the drawings the reference numerals from previous drawings will sometimes not be repeated for structures that have already been identified.

FIG. 1 is a diagram of a cross sectional side view illustrating a prior art copper (Cu) metal layer 120 within an integrated circuit structure 100. The structure 100 that is shown in FIG. 1 includes a substrate 110 in which the copper metal layer 120 is located. The substrate 110 and the copper metal layer 120 are covered with a dielectric layer 130 (e.g., silicon dioxide). A via 140 is formed through the dielectric layer 130 to expose an upper surface 150 of the copper metal layer 120. A strip clean process is performed to clean the exposed upper surface 150 of the copper metal layer 120.

FIG. 2 is a diagram of a cross sectional side view illustrating an alloy layer 210 formed over the copper (Cu) metal layer 120 and the dielectric layer 130. The alloy layer 210 includes (1) a copper platable metal, (2) a nitride forming material and (3) nitrogen. The alloy layer 210 may be formed by co-sputter deposition, chemical vapor deposition (CVD), or other suitable method(s). For purposes of clarity, the thickness of the alloy layer 210 as shown in FIG. 2 is not drawn to scale.

The composition of the alloy layer 210 may be represented by the formula M-X—N where the letter M represents a copper platable metal, where the letter X represents a nitride forming material, and where the letter N represents the element nitrogen.

In one embodiment, the copper platable metal M may be selected from a group of metals having an absolute Gibb's free energy formation of metal oxide that is less than the absolute Gibb's free energy formation of copper oxide. That is, each copper platable metal M in this group satisfies the relationship:

|ΔG_{f}⁰(MO)|<|ΔG_{f}⁰(CuO)| (Equation 1)

where |ΔG_{f}⁰(MO)| is the absolute value of the Gibb's free energy formation of the M metal oxide (MO) and where |ΔG_{f}⁰(CuO)| is the absolute value of the Gibb's free energy formation of copper oxide (CuO). The Gibb's free energy formation of the M metal oxide (MO) must be lower than that of the Gibb's free energy formation of the copper oxide (CuO) in order to be platable. How much lower depends upon the plating conditions. In general, the lower the Gibb's free energy formation of the M metal oxide (MO), the better. Unless the condition in Equation 1 is satisfied, the plating process will not work successfully.

The group of metals M that satisfies Equation 1 includes ruthenium (Ru), indium (Ir), osmium (Os), platinum (Pt), rhodium (Rh) and other similar elements. In one specific embodiment, the metal M is ruthenium (Ru).

In one embodiment, the nitride forming material X may be selected from a group of nitride forming materials (or nitride compounds that enable segregation) having an absolute Gibb's free energy formation of metal nitride that is greater than the absolute Gibb's free energy formation of silicon nitride. That is, the nitride forming material X in this group satisfies the relationship:

|ΔG_{f}⁰(XN)|>|ΔG_{f}⁰(SiN)| (Equation 2)

where |ΔG_{f}⁰(XN)| is the absolute value of the Gibb's free energy formation of the X material nitride (XN) and where |ΔG_{f}⁰(SiN)| is the absolute value of the Gibb's free energy formation of silicon nitride (SiN). The value of the Gibb's free energy formation of silicon nitride (SiN) is:

|ΔG_{f}⁰|(SiN)=−326.10±125.52 kJ (Equation 3)

The group of materials X that satisfies Equation 2 includes the metals tungsten (W), molybdenum (Mo), chromium (Cr) and other similar elements. In one specific embodiment, the material X is the metal tungsten (W).

As long as the Gibb's free energy formation of the X material nitride (XN) is lower than that of ruthenium nitride (RuN) the concept of stabilizing the nitrogen (N) in the amorphous film will work. If the Gibb's free energy formation of the X material nitride (XN) is very low, then a very stable nitride (XN) is formed. However, the layer segregation that is observed with tungsten (W) may not occur.

The segregation of tungsten (W) is due to the nearness of tungsten nitride (WNₓ) to silicon nitride (SiNₓ). Nitrogen (N) atoms can bind with tungsten (W) atoms or silicon (Si) atoms with nearly equal ease because the two nitride ΔG_{f}⁰ values are comparable (i.e., not largely different). This is a very important concept. It is the nearness of the tungsten nitride (WNₓ) to silicon nitride (SiNₓ) that causes migration of the nitrogen (N) atoms towards the silicon (S).

Because the tungsten (W) also prefers to be bound to nitrogen (N) rather than to ruthenium (Ru), the migration of the nitrogen (N) atoms drags the tungsten (W) atoms with it. This process is facilitated by the large amorphous content in the film because the pair-atom migration would be difficult through a crystalline structure.

One embodiment will be described in which the alloy layer 210 is represented by the formula Ru—W—N where the letters Ru represents ruthenium as the copper platable metal, the letter W represents tungsten as the nitride forming material, and the letter N represents the element nitrogen.

After formation, the alloy layer 210 is subjected to a rapid thermal anneal (RTA) process to anneal the alloy layer 210 formed over the copper metal layer 120. The RTA process may be performed in a low pressure atmosphere of nitrogen (N₂), argon (Ar), or a mixture of nitrogen (N₂) and argon (Ar). In one advantageous embodiment, the alloy layer 210 is annealed to a temperature within a range from about two hundred degrees Celsius (200° C.) to about four hundred degrees Celsius (400° C.). The anneal time is preferably from fifteen (15) minutes to thirty (30) minutes.

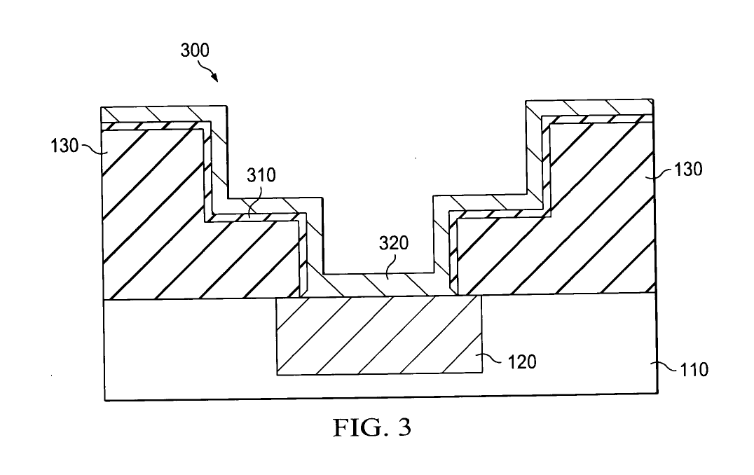

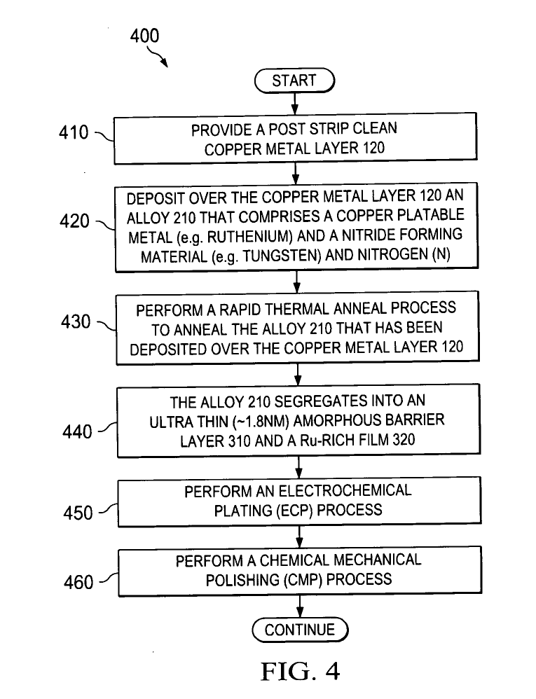

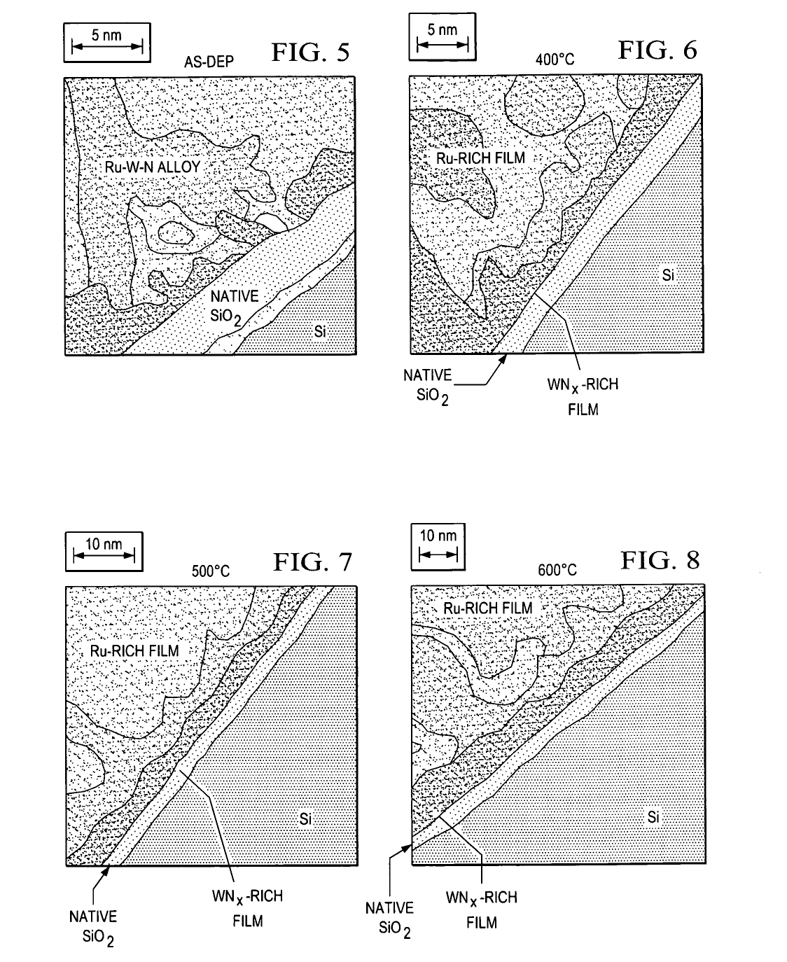

As shown in FIG. 3, the anneal process causes the alloy 210 to segregate into a relatively thin (or ultrathin) (approximately 2 nanometers) amorphous barrier layer 310 and a ruthenium (Ru) rich film layer 320. The amorphous barrier layer 310 includes tungsten nitride (designated WNₓ) (or XN when other X materials are utilized). For purposes of clarity, the thickness of the amorphous barrier layer 310 and the thickness of the ruthenium (Ru) rich film layer 320 as shown in FIG. 3 are not necessarily drawn to scale.

The migration of nitrogen (N) atoms and tungsten (W) atoms toward the silicon (Si) atoms causes the segregation of tungsten-nitrogen (WN) rich layer at the interface with the silicon (Si). Such atomic migration driven segregation can not be expected in ternary alloys that contain elements such as tantalum (Ta) that have significantly lower ΔG_{f}⁰ for its nitrides as compared to the silicon (Si) nitrides.

It has been determined that the alloy layer 210 formed of ruthenium (Ru) and tungsten (W) and nitrogen (N) (i.e., M, X, N) retains the nitrogen (N) in solution within the alloy 210 even when the alloy layer 210 is subjected to higher temperatures. This is because the amorphous barrier layer 310 is a stable amorphous nitride. The retention of the nitrogen (N) in solution within the amorphous barrier layer 310 provides a beneficial effect on the diffusion barrier performance.

In addition, it has been determined that the alloy layer 210 of ruthenium (Ru) and tungsten (W) and nitrogen (N) (i.e., M, X, N) delays the recrystallization of the amorphous layer to a significantly higher temperature (to approximately 500° C. to 600° C.). This feature also provides a beneficial effect on the diffusion barrier performance.

As previously mentioned, annealing the alloy 210 at a temperature between about 200° C. and 400° C. causes a natural segregation of the alloy 210 into an amorphous barrier layer 310 and a ruthenium (Ru) rich film layer 320. The natural segregation creates a ruthenium (Ru) rich film layer 320 (copper seed layer) in the top portion of the alloy layer 210. This provides a beneficial effect for the seeding properties for a subsequent copper (Cu) electrochemical plating (ECP) process. The natural segregation also creates an amorphous WNₓ layer 310 (barrier layer) in the bottom portion of the alloy layer 210 adjacent the dielectric layer 130. The amorphous WNₓ layer 310 provides good diffusion barrier properties and is generally stable up to a temperature of about seven hundred degrees Celsius (700° C.).

FIG. 4 is a diagram illustrating a flowchart of one method of forming the alloy layer 210, and the subsequent layers 310 and 320. Initially, the exposed copper metal is subjected to a post strip clean copper metal process (step 410) to clean and prepare the exposed surface of the copper metal layer 120 (and perhaps the dielectric layer 130). The alloy layer 210 is formed over the copper metal layer 120 and surfaces (top and sidewalls) of the dielectric layer 130. The alloy layer 210 includes the elements M (copper platable metal), X (nitride forming material) and N (nitrogen) as described above, and in the embodiment and example shown, includes a ruthenium (Ru), tungsten (W) and nitrogen (N) (step 420). As described previously, other M and X elements may be utilized to form the alloy layer 210.

A rapid thermal anneal (RTA) process is performed to anneal the alloy layer 210 (step 430). During this process, the alloy layer 210 segregates into the amorphous barrier layer 310 (tungsten nitride) and the ruthenium (Ru) rich film layer 320, thus forming these two layers (step 440) (also refer to FIG. 3). Thereafter, an electrochemical plating (ECP) process may be performed (step 450), followed by a chemical mechanical polishing (CMP) process (step 460) to planarize the copper surface.

The alloying and formation of ruthenium (Ru) with tungsten (W) may be achieved by co-sputtering a ruthenium (Ru) target and a tungsten (W) target within conventional sputtering equipment in a nitrogen (N) atmosphere to dissolve the nitrogen (N). Alternatively, a pre-alloyed ruthenium (Ru)/tungsten (W) single target could be used. Other suitable methods of formation or processing may be utilized.

Tungsten (W) has a high affinity to nitrogen (N) in the alloy layer 210 preventing the expulsion of the nitrogen (N) and thereby preventing the crystallization of pure ruthenium (Ru). A natural segregation occurs in the alloy layer 210 when it is heated to a temperature of about two hundred degrees Celsius (200° C.). The initial amorphous layer, which had a homogeneous chemistry, segregates to form a bilayer (layers 310 and 320).

The amorphous tungsten nitride (WNₓ) barrier layer 310 is formed adjacent the surface (top and sidewalls) of the dielectric 130 for those portions of the alloy layer 210 that overlay the dielectric layer 130. The ruthenium (Ru) rich film layer 320 is formed above the amorphous tungsten nitride (WNₓ) barrier layer 310. Above the copper layer 120, the layer 310 does not form.

This is a particularly advantageous barrier layer structure because (1) the lower amorphous tungsten nitride (WNₓ) barrier layer 310 exhibits good diffusion barrier properties of pure tungsten nitride (WNₓ), and (2) the ruthenium (Ru) rich film 320 provides desirable seeding properties for copper (Cu) metallization. The present disclosure provides a naturally formed bilayer (310, 320) with excellent adhesion between the two layers. The naturally formed bilayer (310, 320) is created from a single layer (210) by the controlled application of heat and not by a dual layer deposition process.

The method(s) described herein provides significant advantages over a conventionally formed WNₓ/Ru double layer (i.e., a double layer that is formed by two separate deposition steps) due to the utilization of a single step formation/deposition process. The method(s) also provides a relatively thin WNₓ layer 310 that is thinner than the barrier layer formed in a conventionally formed double layer. The WNₓ layer 310 is also amorphous, while a conventionally formed WNₓ layer is formed by direct sputtering that creates a WNₓ layer that has a columnar microstructure. The amorphous form of the WNₓ layer exhibits better diffusion barrier properties than a conventional columnar microstructure of a conventional WNₓ layer.

As described above, one specific embodiment of the barrier/seed bilayer (310,320) of the present disclosure includes is the formation of a ruthenium-tungsten-nitrogen (Ru—W—N) alloy. It will be understood that ruthenium (Ru) may be replaced by any one of the metals in the group of metals that satisfies the condition that is set forth in Equation 1 above. It is also understood that the tungsten (W) may be replaced by any one of the materials in the group of materials that satisfies the condition that is set forth in Equation 2 above.

FIG. 5 is a transmission electron microscopy (TEM) bright field micrograph that shows a ruthenium-tungsten-nitrogen (Ru—W—N) alloy that has been deposited over a silicon (Si) substrate. A layer of native silicon dioxide (SiO₂) is located between the Ru—W—N alloy and the underlying silicon (Si) substrate. The as-deposited Ru—W—N alloy has a predominantly amorphous microstructure with few nanocrystals. The Ru—W—N alloy appears to be homogeneous across its thickness.

The structure shown in FIG. 5 is then annealed at four hundred degrees Celsius (400° C.). FIG. 6 is a TEM bright field micrograph that shows the ruthenium-tungsten-nitrogen (Ru—W—N) alloy of FIG. 5 after the alloy has been annealed at four hundred degrees Celsius (400° C.). After the annealing process has been performed, a relatively thin (2 nm) dark continuous layer is formed at the interface of the Ru—W—N alloy and the silicon dioxide (SiO₂) layer. The dark continuous layer that is shown in FIG. 6 is the WNₓ rich film layer 310 previously described.

The structure that is shown in FIG. 6 is then annealed at the higher temperatures of five hundred degrees Celsius (500° C.), six hundred degrees Celsius (600° C.), seven hundred degrees Celsius (700° C.), and then eight hundred degrees Celsius (800° C.). FIGS. 7 through 10 are TEM bright field micrographs illustrating the ruthenium-tungsten-nitrogen (Ru—W—N) alloy after the alloy has been annealed at the indicated temperatures of five hundred degrees Celsius (500° C.) through eight hundred degrees Celsius (800° C.). The average thickness of the dark WNₓ rich layer increases with each increase in annealing temperature. The dark WNx rich layer eventually disappears after the temperature reaches eight hundred degrees Celsius (800° C.) due to the release of nitrogen (N) from the layer.

FIG. 11 is a TEM bright field micrograph that shows a ruthenium-tungsten-nitrogen (Ru—W—N) alloy film layer on a silicon substrate after the alloy has been annealed at about four hundred degrees Celsius (400° C.). As shown in FIG. 11, an interface location (designated A) is selected within the dark WNₓ rich layer 310. A bulk location (designated B) is selected within the bulk of the Ru—W—N alloy.

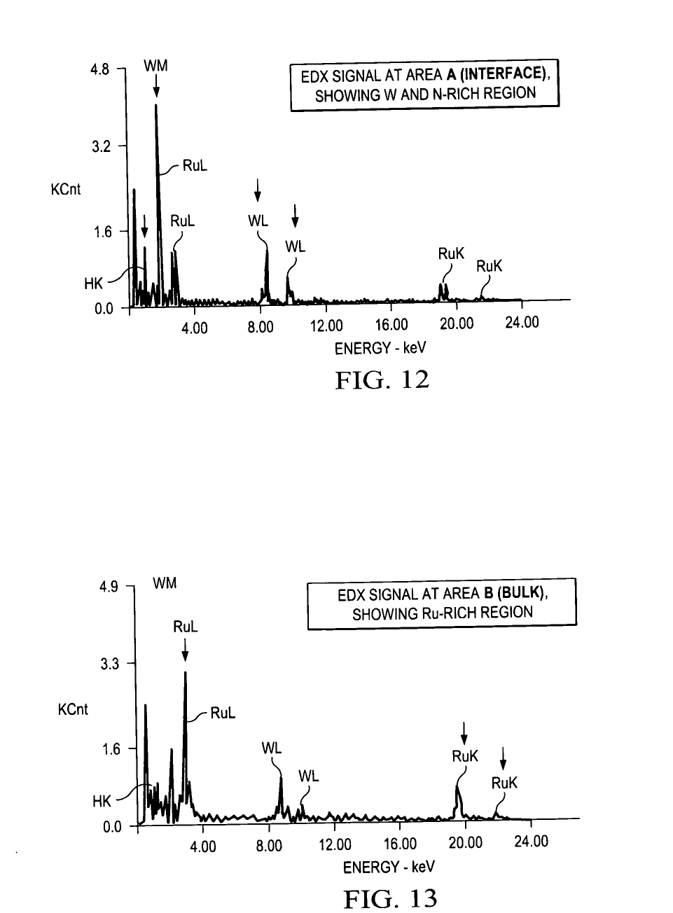

An energy dispersive X-ray (EDX) spectroscopy signal is applied to dark WNₓ rich layer 310 at the interface location A. The result of applying the EDX spectroscopy signal to the interface location A is shown in FIG. 12.

An energy dispersive X-ray (EDX) spectroscopy signal is then applied to the Ru—W—N alloy at the bulk location B. The result of applying the EDX spectroscopy signal to the bulk location B is shown in FIG. 13.

It will be understood that well known processes have not been described in detail and have been omitted for brevity. Although specific steps, structures and materials may have been described, the present disclosure may not limited to these specifics, and others may substituted as is well understood by those skilled in the art.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of manufacturing a diffusion barrier for copper metallization in an electronic device, the method comprising:
providing a copper layer and a dielectric layer within the electronic device; and
forming over the dielectric layer and the copper layer a single layer of an alloy, the alloy comprising a copper platable metal and a nitride forming material and nitrogen.

2. The method as set forth in claim 1 further comprising: annealing the single layer of the alloy to form
a first layer positioned adjacent to a surface of the dielectric layer wherein the layer comprises the nitride forming material and the nitrogen, and
a second layer positioned adjacent to the first layer wherein the second layer comprises the copper platable metal.

3. The method as set forth in claim 1 wherein the copper platable metal is selected from a group of metals that have an absolute Gibb's free energy formation of metal oxide that is less than that of copper oxide.

4. The method as set forth in claim 1 wherein the copper platable metal is selected from a group of metals consisting of ruthenium, indium, osmium, platinum and rhodium.

5. The method as set forth in claim 1 wherein the nitride forming material is selected from a group of nitride forming materials that have an absolute Gibb's free energy formation of metal nitride that is greater higher than that of silicon nitride.

6. The method as set forth in claim 1 wherein the nitride forming material is selected from a group of materials consisting of tungsten, molybdenum and chromium.

7. The method as set forth in claim 1 wherein the copper platable metal of the alloy comprises ruthenium and the nitride forming material comprises tungsten.

8. The method as set forth in claim 7 further comprising:
annealing the single layer of the alloy; and
segregating the single layer of the alloy into
a first layer that comprises a barrier layer that is located adjacent to a surface of the dielectric layer wherein the barrier layer comprises tungsten and nitrogen, and
a second layer that is adjacent to the first layer wherein the second layer comprises ruthenium.

9. The method as set forth in claim 8 wherein the annealing the single layer of the alloy comprises:
annealing the single layer of the alloy to a temperature between about two hundred degrees Celsius and about four hundred degrees Celsius.

10. The method as set forth in claim 8 wherein the first layer comprises an amorphous tungsten nitride layer that has a thickness of less than about 2 nanometers.

11. The method as set forth in claim 8 wherein the first layer comprises an amorphous tungsten nitride layer that retains nitrogen in solution when the alloy is heated.

12. The method as set forth in claim 8 wherein the first layer comprises an amorphous tungsten nitride layer that is stable up to a temperature of seven hundred degrees Celsius.

13. The method as set forth in claim 8 wherein the second layer comprises a ruthenium rich film that provides a seed layer for copper electrochemical plating.

14. The method as set forth in claim 8 wherein the first layer comprises an amorphous tungsten nitride layer that prevents an expulsion of nitrogen from the first layer that delays a crystallization of the ruthenium in the second layer up to a temperature in a range of about five hundred degrees Celsius to about six hundred degrees Celsius.

15. A method of manufacturing a diffusion barrier for copper metallization in an electronic device, the method comprising:
providing a dielectric layer within the electronic device; and
forming over the dielectric layer a single layer of an alloy comprising ruthenium and tungsten and nitrogen.

16. The method as set forth in claim 15 further comprising:
annealing the single layer of the alloy to a temperature between about two hundred degrees Celsius and about four hundred degrees Celsius; and
segregating the single layer of the alloy into
a first layer that comprises a barrier layer that is located adjacent to a surface of the dielectric layer wherein the barrier layer comprises tungsten and nitrogen, and
a second layer that is adjacent to the first layer wherein the second layer comprises ruthenium.

17. The method as set forth in claim 16 wherein the first layer comprises an amorphous tungsten nitride layer that has a thickness that is less than a thickness of a barrier layer that is formed by two separate deposition steps.

18. The method as set forth in claim 16 wherein the first layer comprises an amorphous tungsten nitride layer that has an amorphous form that provides better diffusion barrier properties than a conventional columnar microstructure of a diffusion barrier that is formed by two separate deposition steps.

19. A diffusion barrier structure for copper metallization in an electronic device having a copper layer, the diffusion barrier structure comprising:
a single layer of an alloy formed over the copper layer and a dielectric layer wherein the alloy includes a copper platable metal and a nitride forming material and nitrogen.

20. A diffusion barrier structure as set forth in claim 19 wherein the single layer of the alloy is segregated into
a first layer that comprises a barrier layer that is located adjacent to a surface of the dielectric layer wherein the barrier layer comprises the nitride forming material and nitrogen; and
a second layer that that is adjacent to the first layer wherein the second layer comprises the copper platable material.

21. A diffusion barrier structure as set forth in claim 20 wherein the copper platable material is ruthenium and the nitride forming material is tungsten.
